(19) United States
(12) Patent Application Publication
(10) Pub. No.: US 2006/0185460 A1
(43) Pub. Date: Aug. 24, 2006

(54) Rack and pinion steering device

(75) Inventors: Kohtaro Shiino, Kanagawa (JP); Toshiro Yoda, Saitama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/354,133

(22) Filed: Feb. 15, 2006

(30) Foreign Application Priority Data
Feb. 22, 2005 (JP) 2005-044942

(51) Int. Cl. F16H 35/00

(52) U.S. Cl. 74/422

(57) ABSTRACT

A pinion shaft rotated by a steering wheel has a pinion gear formed thereon. A rack bar has at a front surface thereof a toothed rack portion meshed with the pinion gear of the pinion shaft. A rotating member is arranged to support a rear surface of the rack bar while being permitted to rotate when the rack bar moves axially. A biasing mechanism that biases the rotating member toward an actually meshed portion between the toothed rack portion and the pinion gear. A supporting member is arranged to slidably support the rear surface of the rack bar.

### BACKGROUND OF THE INVENTION

1. Field of the Invention

The present invention relates in general to rack and pinion steering devices for wheeled motor vehicles, and more particularly to the steering devices of a type that has such an arrangement as to stable and assure the engagement between a pinion shaft and a rack bar.

2. Description of the Related Art

One of known steering devices of the above-mentioned type is described in Japanese Laid-open Patent Application (Tokkai) 2004-34829. The steering device of the publication generally comprises a pinion shaft that is connected to a steering wheel, and a rack bar that is meshed with the pinion shaft, so that when, due to turning of the steering wheel, the pinion shaft is turned, the rack bar is moved axially in right or left direction inducing a steered movement of steered road wheels. In the steering device of the publication, the rack bar has at a front surface thereof racks meshed with teeth of the pinion shaft and at a back surface thereof a projected portion, and a cylindrical rack retainer is rotatably provided at the back side of the rack bar to assure the engagement between the racks and the teeth. That is, the cylindrical rack retainer is arranged to push the projected portion to bias the rack bar toward the pinion shaft. Due to the cylindrical shape of the rack retainer and rotatable arrangement of the same, a sliding resistance produced between the rack bar and the rack retainer under movement of the rack back is minimized.

### SUMMARY OF THE INVENTION

However, even the above-mentioned steering device of the publication fails to exhibit a satisfied performance against the biasing force of the rack retainer that causes a vertical pivoting of the rack bar about an actually meshed portion between the racks of the rack bar and the teeth of the pinion shaft. As is known, such pivoting movement deteriorates smoothed operation of the steering device.

It is therefore an object of the present invention to provide a rack and pinion steering device which is free of the undesired vertical pivoting of the rack bar.

It is another object of the present invention to provide a rack and pinion steering device which is simple in construction.

In accordance with a first aspect of the present invention, there is provided a rack and pinion steering device which comprises a pinion shaft being adapted to be rotated by a steering wheel, the pinion shaft having a pinion gear formed thereon; a rack bar having at a front surface thereof a toothed rack portion meshed with the pinion gear of the pinion shaft; a rotating member being arranged to support a rear surface of the rack bar while being permitted to rotate when the rack bar moves axially; a first biasing mechanism biasing the rotating member toward an actually meshed portion between the toothed rack portion of the rack bar and the pinion gear of the pinion shaft; and a supporting member being arranged to slidably support the rear surface of the rack bar.

In accordance with a second aspect of the present invention, there is provided a rack and pinion steering device which comprises a pinion shaft being adapted to be rotated by a steering wheel, the pinion shaft having a pinion gear formed thereon; a rack bar having at a front surface thereof a toothed rack portion meshed with the pinion gear of the pinion shaft; a rotating member being arranged to support a rear surface of the back bar while being permitted to rotate when the rack bar moves axially; a biasing mechanism biasing the rotating member toward an actually meshed portion between the toothed rack portion of the rack bar and the pinion gear of the pinion shaft; and a sliding member slidably contacing the rear surface of the rack bar to support the rack bar.

In accordance with a third aspect of the present invention, there is provided a rack and pinion steering device which comprises a pinion shaft being adapted to be rotated by a steering wheel, the pinion shaft having a pinion gear formed thereon; a rack bar having at a front surface thereof a toothed rack portion meshed with the pinion gear of the pinion shaft; a first supporting member being arranged to support a rear surface of the rack bar with a predetermined biasing force; and a second supporting member being arranged at a back side of the rack bar and constructed to control movement of the rack bar when the rack bar is applied with an external force greater than the predetermined biasing force.

Other objects and advantages of the present invention will become apparent from the following description when taken in conjunction with the accompanying drawings.

### BRIEF DESCRIPTION OF THE DRAWINGS

FIG. 1 is a sectional view of a rack and pinion steering device which is a first embodiment of the present invention;

FIG. 2 is an enlarged sectional view of an essential portion of the rack and pinion steering device of the first embodiment;

FIG. 3 is a partially cut perspective view of a rack bar that is employed in the present invention;

FIG. 4 is an exploded view of a supporting unit for supporting the rack bar, which is employed in the first embodiment of the present invention;

FIG. 5 is a view similar to FIG. 2, but showing a second embodiment of the present invention;

FIG. 6 is a view also similar to FIG. 2, but showing a third embodiment of the present invention;

FIG. 7A is a view taken from the direction of arrow “A” of FIG. 6; and

FIG. 7B is a view taken from the direction of arrow “B” of FIG. 7A with some parts removed.

### DETAILED DESCRIPTION OF THE EMBODIMENTS

In the following, three embodiments 100, 200 and 300 of the present invention will be described in detail with reference to the accompanying drawings.

For ease of understanding, various directional terms, such as right, left, upper, lower, rightward and the like are used in the following description. However, such terms are to be understood with respect to only a drawing or drawings on which a corresponding part or portion is shown.

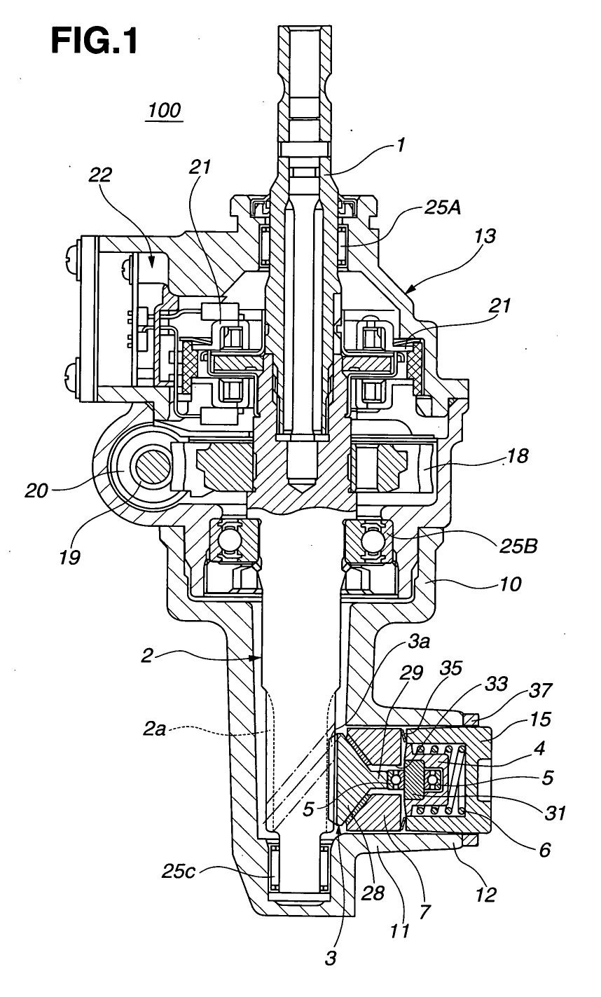

Referring to FIGS. 1 to 4, there is shown a rack and pinion steering device 100 which is a first embodiment of the present invention.

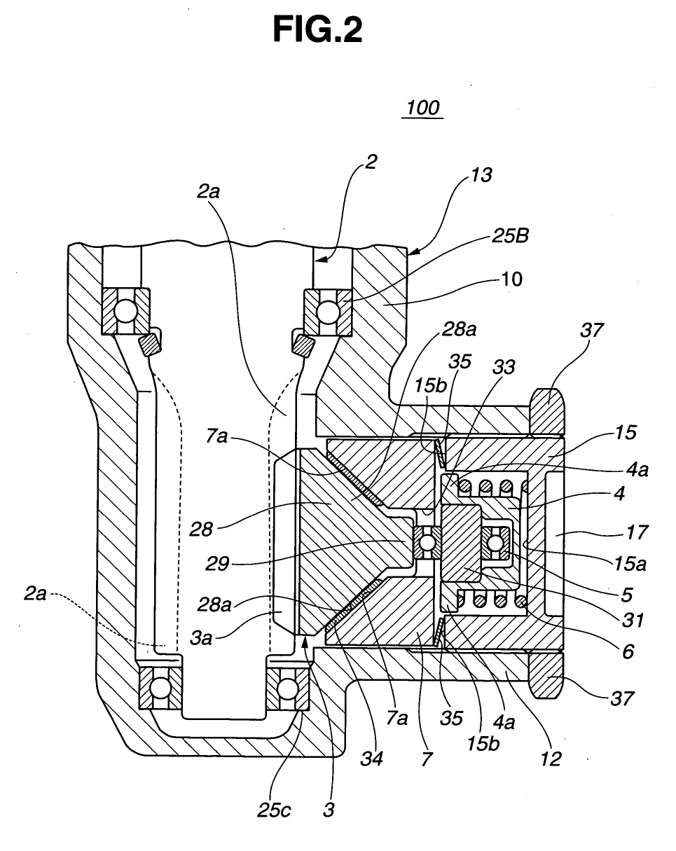

As is seen from FIGS. 1 and 2, the steering device 100 comprises a steering shaft 1 that is connected to a steering wheel (not shown) to rotate therewith, a pinion shaft 2 that is coaxially connected to steering shaft 1 and has at a leading end portion thereof a pinion gear 2a, a worm wheel 18 that is coaxially and tightly disposed on pinion shaft 2 to rotate therewith, a worm shaft 19 that is meshed with worm wheel 18, an electric motor 20 that drives worm shaft 19 with an electric power, a rotation angle sensor 21 that is arranged about pinion shaft 2 to detect an angular position of pinion shaft 2 and an electric motor control unit 22 that controls electric motor 20 in accordance with an output signal from rotation angle sensor 21.

As will be understood hereinafter, worm wheel 18, worm shaft, electric motor 20, rotation angle sensor 21 and electric motor control unit 22 constitute a so-called electric power steering system that aids the driver in turning the steering wheel for steering an associated motor vehicle.

Meshed with pinion gear 2a of pinion shaft 2 is a toothed rack portion 3a formed on a front surface of a rack bar 3. Although not shown in the drawings, rack bar 3 has at axial ends thereof respective tie rods to which steering arms from respective steered road wheels are connected.

Behind rack bar, there is arranged a cylindrical rack retainer 4 for retaining or holding rack bar 3.

Cylindrical rack retainer 4 has a ball bearing 5 mounted thereabout. As will be described in detail hereinafter, ball bearing 5 comprises an inner race mounted about a bearing shaft 31, an outer race contacting a back ridge (or raised straight rail portion) 29 of rack bar 3 and a plurality of balls operatively disposed between the inner and outer races.

For biasing ball bearing 5 leftward in FIGS. 1 and 2, that is, toward an actually meshed portion between pinion gear 2a of pinion shaft 2 and toothed rack portion 3a of rack bar 3, there is employed a coil spring 6. For stably supporting rack bar 3 that is axially slidable, there is employed a supporting member 7. Cylindrical rack retainer 4, ball bearing 5, coil spring 6, supporting member 7 and associated parts are housed in a housing 13. The detail of these elements and parts will be described hereinafter.

As is seen from FIG. 1, housing 13 generally comprises a pinion housing part 10 that contains therein pinion shaft 2 and associated parts of the same, a rack bar housing part 11 that contains therein both rack bar 3 and supporting member 7 and a rack retainer housing part 12 that contains therein cylindrical rack retainer 4 and associated parts of the same. As is seen from FIGS. 1 and 2, rack retainer housing part 12 has an outside open end to which a cap member 15 is detachably connected via a threaded connection.

As is seen from FIGS. 1 and 2, rack bar 3 extends substantially perpendicular to pinion shaft 2. Toothed rack portion 3a of rack bar 3 and pinion gear 2a of pinion shaft 2 are meshed with each other in a helical gear connection manner. When, thus, pinion shaft 2 is turned about its axis, rack bar 3 is forced to slide in an axial direction.

As is described hereinabove, pinion shaft 2 is connected to the steering wheel (not shown) through steering shaft 1, and an elongate unit including pinion shaft 23 and steering shaft 1 is rotatably received in housing 13 through three bearings 25A, 25B and 25C, as shown.

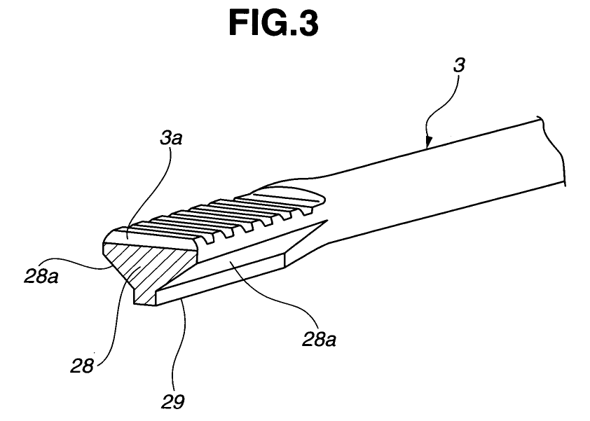

As is seen from FIG. 3, rack bar 3 has an axially middle portion 28 that has at a front side thereof toothed rack portion 3a meshed with pinion gear 2a of pinion shaft 2. The middle portion 28 has at its back side a raised straight rail portion 29 that has a generally rectangular cross section. As shown, middle portion 28 has further a pair of slanted surfaces 28a and 28a that extend gently from rail portion 29 to laterally opposed ends of the front side of the middle portion 28. In the illustrated embodiment, slanted surfaces 28a and 28a are arranged symmetrically with respect to the axis of rack bar 3.

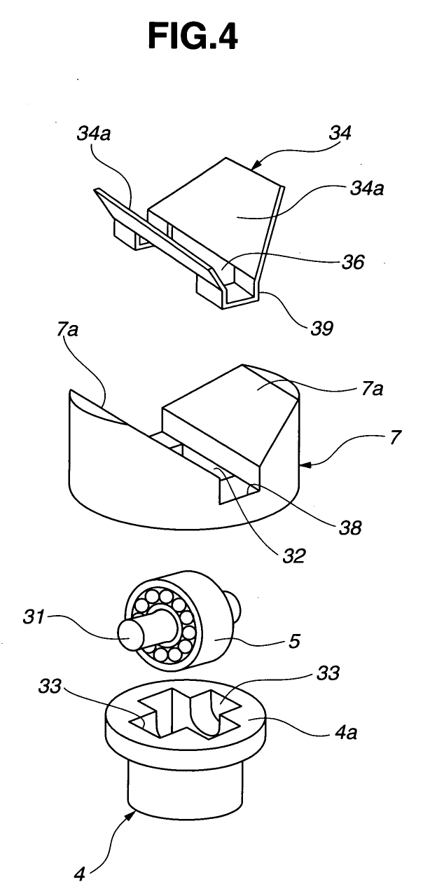

As is best seen from FIG. 2, in assembly, rail portion 29 of rack bar 3 is in contact with the outer race of ball bearing 5, so that the axial movement of rack bar 3 is smoothed by a followed rotation of the outer race of ball bearing 5. As is seen from FIGS. 2 and 4, ball bearing 5 has bearing shaft 31 disposed in the inner race thereof.

As is best seen from FIG. 4, ball bearing 5 is held by cylindrical rack retainer 4 through bearing shaft 31. Thus, cylindrical rack retainer 4 not only supports ball bearing 5 through bearing shaft 31 but also supports raised straight rail portion 29 of rack bar 3 through ball bearing 5.

Cylindrical rack retainer 4 is integrally formed at its front side with an annular flange 4a, and has diametrically opposed rounded recesses (or shaft receiving grooves) 33 and 33 for rotatably supporting axially opposed ends of bearing shaft 31 of ball bearing 5. Rack retainer 4 has further between the rounded recesses 33 a larger rounded recess (no numeral) for housing ball bearing 5.

Supporting member 7 is generally cylindrical in shape. As shown, supporting member 7 is formed at diametrically opposed portions thereof with a pair of slanted supporting surfaces 7a and 7a that are constructed and sized to support slanted surfaces 28a and 28a of rack bar 3, and at a middle portion thereof with a straight groove 38 that houses therein raised straight rail portion 29 of rack bar 3. Straight groove 38 is formed at a middle portion thereof a first rectangular opening 32 that is sized to house therein part of ball bearing 5. That is, in assembly, a part of ball bearing 5 is put through rectangular opening 32 to contact the rail portion 29 of back bar 3.

On slanted supporting surfaces 7a and 7a of supporting member 7, there is put a generally V-shaped bearing sheet 34 of metal. Preferably, the sheet 34 is coated with a low friction plastic, such as Teflon (trade mark) or the like.

As shown, bearing sheet 34 comprises a pair of wing portions 34a and 34a that are to be neatly placed on slanted supporting surfaces 7a and 7a of supporting member 7, and a center groove portion 39 that extends between base sections of respective wing portions 34a and 34a and is to be received in straight groove 38 of supporting member 7. Center groove portion 39 is formed with a second rectangular opening 36. As shown, second rectangular opening 36 is larger than the above-mentioned first rectangular opening 32 of supporting member 7. In assembly, center groove portion 39 is neatly put in straight groove 38 of supporting member 7 allowing second rectangular opening 36 to entirely cover first rectangular opening 32.

Returning back to FIG. 2, coil spring 6 is compressed between annular flange 4a of rack retainer 4 and a bottom wall 15a of cap member 15, so that rack retainer 4 and thus also bearing shaft 31, ball bearing 5 and rack bar 3 are all biased leftward in the drawing, that is, toward pinion shaft 2.

With such biasing action, the meshed engagement between toothed rack portion 3a of rack bar 3 and pinion gear 2a of pinion shaft 2 is assuredly made.

As is best seen in FIG. 2, a disc spring 35 is operatively compressed between supporting member 7 and a leading end 15b of cap member 15, so that supporting member 7 is biased toward the toothed middle portion 28 of rack bar 3. With this, the V-shaped bearing sheet 34 is neatly and stably set between slanted supporting surfaces 7a and 7a of supporting member 7 and slanted surfaces 28a and 28a of the middle portion 28 of rack bar 3. Furthermore, with such biasing action by disc spring 35, the meshed engagement between toothed rack portion 3a of rack bar 3 and pinion gear 2a of pinion shaft 2 is much assuredly made. Disc spring 35 has a spring constant smaller than that of coil spring 6. Thus, when applied with the same load, disc spring 35 shows a larger expansion/contraction than coil spring 6.

As is understood from the above, the meshed engagement between rack bar 3 and pinion shaft 2 is assuredly made by the biasing force that is produced by disc spring 35 as well as coil spring 6. As will be understood from FIG. 2, the compressed degree of disc spring 35 and coil spring 6 can be controlled by adjusting the degree by which cap member 15 gets into rack retainer housing part 12 of housing 13.

Coil spring 6 and disc spring 35 are held in rack retainer housing part 12 while being held by and holding cap member 15 in the above-mentioned manner. Thus, these springs 6 and 35 can be easily set in position. As shown, cap member 15 is formed with an externally threaded cylindrical part with which a connecting nut 37 is meshed, and cap member 15 has at an outside end a tool catching slit 17 with which a suitable tool (not shown) is engageable. Thus, when, with cap member 15 being kept stationary by the tool engaged with the slit 17, connecting nut 37 is turned in a certain direction, the degree by which cap member 15 gets into rack retainer housing part 12 is adjusted.

In the following, operation of the rack and pinion steering device 100 of the first embodiment will be described with reference to the drawings, especially FIG. 1.

When for example a driver handles the steering wheel (not shown) for steering an associated motor vehicle, steering shaft 1 and thus pinion shaft 2 are rotated about a common axis. During the rotation, rotation angle sensor 21 detects an angular position of pinion shaft 2 and a corresponding output signal from the sensor 21 is inputted to electric motor control unit 22. Processing the signal, control unit 22 controls electric motor 20, that is, controls a rotation amount of worm shaft 19 driven by electric motor 20. With this, the angular position of worm wheel 18 meshed with work shaft 19 is controlled thereby to control the angular position of pinion shaft 2. That is, the effort of the driver for steering the motor vehicle is assisted by the power produced by electric motor 20.

In response to the rotation of pinion shaft 2, rack bar 3 is forced to move horizontally rightward or leftward. During this movement of rack bar 3, the raised straight rail portion 29 of rack bar 3 is kept pressed by ball bearing 5 while rotating the outer race of ball bearing 5, and slanted surfaces 28a and 28a of middle portion 28 of rack bar 3 are forced to slide on bearing sheet 34, more particularly, on wing portions 34a and 34a of bearing sheet 34.

During the axial movement of rack bar 3, there may be such a possibility of inducing a pivotal motion of rack bar 3 about the mutually meshed portion between rack bar 3 and pinion shaft 2, more specifically, about the meshed portion between teeth rack portion 3a of rack bar 3 and pinion gear 2a of pinion shaft 2 because of a friction drag inevitably produced at the meshed portion and the other resistance.

However, for the following reasons, such undesired pivotal motion of rack bar 3 is suppressed or at least minimized.

That is, slanted surfaces 28a and 28a of middle portion 28 of rack bar 3 are stably supported on slanted supporting surfaces 7a and 7a of supporting member 7 through V-shaped bearing sheet 34, and the biasing force of disc spring 35, that functions to press supporting member 7 against slanted surfaces 28a and 28a of rack bar 3, stably supports rack bar 3 on slanted supporting surfaces 7a and 7a of supporting member 7, which suppresses or at least minimizes the undesired pivotal motion of rack bar 3.

As is described hereinabove, since disc spring 35 has a spring constant smaller than that of the coil spring 6, the force by which rack bar 3 is biased toward pinion shaft 2 is mainly made by coil spring 6 with the aid of ball bearing 5, and supporting member 7 is supported by disc spring 35.

Accordingly, since toothed rack portion 3a of rack bar 3 is biased or pressed to pinion gear 2a of pinion shaft 2 by the force of coil spring 6 and the supporting member 7 is biased or pressed to slanted flat surfaces 28a and 28a of rack bar 3 by the force of disc spring 35, the force by which supporting member 7 is pressed against rack bar 3 does not become too large and thus the axial movement of rack bar 3 can be smoothly made without inducing the above-mentioned undesired pivotal motion thereof.

A so-called “flat surface to flat surface supporting” achieved by slanted flat surfaces 28a and 28a and slanted supporting surfaces 7a and 7a functions to minimize such undesired pivotal motion of rack bar 3. Furthermore, a so-called “V-coupling sliding engagement” achieved by such slanted surfaces 28a, 28a, 7a and 7a suppresses pivoting of rack bar 3 in universal directions.

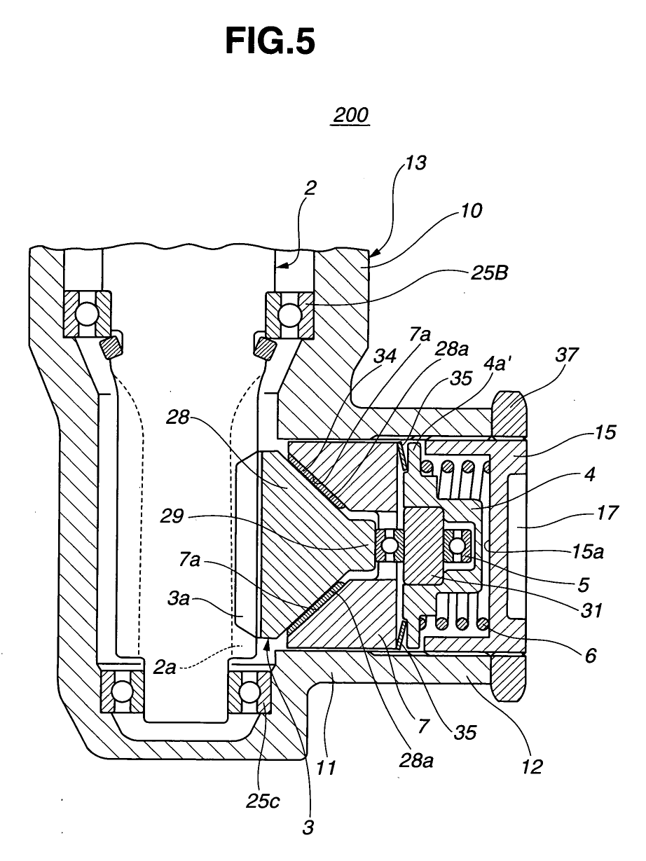

Referring to FIG. 5, there is shown a rack and pinion steering device 200 which is a second embodiment of the present invention.

Since the second embodiment 200 is similar in construction to the above-mentioned first embodiment 100, only portions or parts that are different from those of the first embodiment 100 will be described in the following.

That is, in the second embodiment 200, the annular flange 4a′ of cylindrical rack retainer 4 is made larger in size, and disc spring 35 is compressed between annular flange 4a′ and supporting member 7. Due to the biasing force of disc spring 35, supporting member 7 stably supports the toothed middle potion 28 of rack bar 3.

That is, also in this second embodiment 200, like in the first embodiment 100, the meshed engagement between pinion gear 2a of pinion shaft 2 and toothed rack portion 3a of rack bar 3 is assuredly made by the biasing action effected by coil spring 6 and ball bearing 5, and undesired pivotal motion of rack bar 3 is suppressed or at least minimized by the biased supporting member 7.

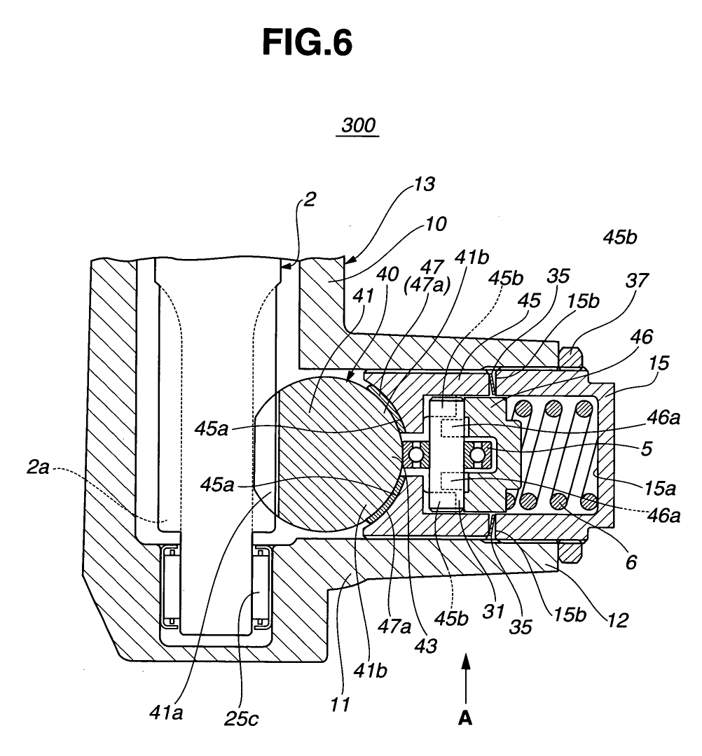

Referring to FIG. 6, there is shown a rack and pinion steering device 300 which is a third embodiment of the present invention.

Since the third embodiment 300 is similar in construction to the above-mentioned first embodiment 100 too, only portions or parts that are different from those of the first embodiment 100 will described in the following.

In this third embodiment 300, the rack bar 40 used is a cylindrical bar. As shown, cylindrical rack bar 40 is formed on a front cylindrical surface of an axially middle portion 41 thereof with a toothed rack portion 41a. Due to the cylindrical shape of the middle portion 41 of rack bar 40, each tooth of rack portion 41a formed on the front surface has rounded ends, and the rear surface of middle portion 41 is shaped round as shown.

As shown, the most projected part of the rear surface of middle portion 41 constitutes a so-called “raised straight rail portion” 43 that is in contact with the outer race of ball bearing 5.

As shown, middle portion 41 of cylindrical rack bar 40 has at upper and lower sides of raised straight rail portion 43 respective cylindrical surfaces 41b and 41b that are supported by concave supporting surfaces 45a and 45a of a cylindrical supporting member 45 through rounded wing portions 47a and 47a of a bearing sheet 47. That is, bearing sheet 47 is substantially the same as the above-mentioned V-shaped bearing sheet 34 except that in bearing sheet 34, wing portions 47a and 47a are rounded.

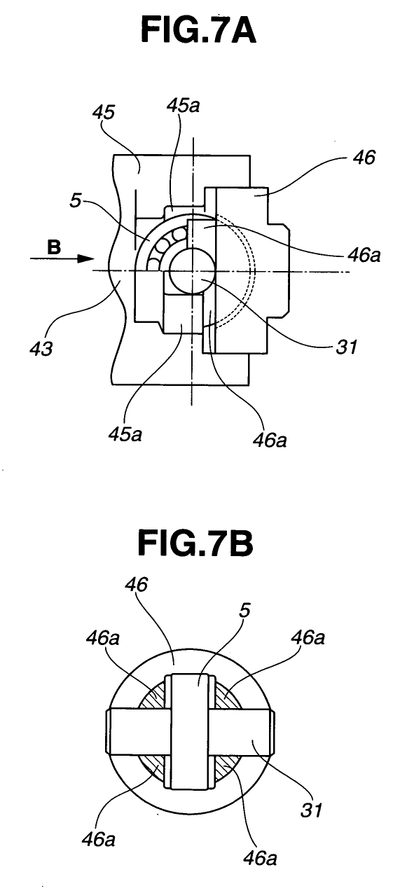

As is understood from FIG. 7, in this third embodiment 300, like in the above-mentioned first embodiment 100, middle portion 41 of rack bar 40 is biased toward pinion shaft 2 by the biasing action effected by coil spring 6 and ball bearing 5, and middle portion 41 is stably held by supporting member 45 that is biased toward middle portion 41 by means of disc spring 35.

In the following, the detail of supporting member 45 and cylindrical rack retainer 46 will be described with reference to FIGS. 6, 7A and 7B.

As is understood from FIGS. 6 and 7A and will be imagined from FIG. 4, cylindrical supporting member 45 is formed at one end thereof, viz., at a left end in FIG. 6, with concave supporting surfaces 45a and 45a and at the other end, viz., at a right end in FIG. 6, with a cylindrical recess (no numeral) into which cylindrical rack retainer 46 axially movably received.

The cylindrical recess of supporting member 45 is formed at a bottom wall thereof with shaft bearing portions 45b and 45b that rotatably support axially opposed ends of bearing shaft 31. As has been mentioned hereinabove, bearing shaft 31 passes through the inner race of ball bearing 5.

As is seen from FIG. 6, between supporting member 45 and cap member 15, there is compressed disc spring 35 for pressing or biasing concave supporting surfaces 45a and 45a of supporting member 45 against respective cylindrical surfaces 41b and 41b of middle portion 41 of rack bar 40 through the V-shaped bearing sheet 34. Between rack retainer 46 and bottom wall 15a of cap member 15, there is compressed coil spring 6 for pressing or biasing middle portion 41 toward pinion shaft 2.

As is seen from FIGS. 6 and 7B and as will be imagined from FIG. 4, rack retainer 46 has at its left end in FIG. 6 shaft bearing portions 46a and 46a for rotatably receiving bearing shaft 31 of ball bearing 5. That is, in assembly, bearing shaft 31 is rotatably held by shaft bearing portions 45b and 45b of supporting member 45 and shaft bearing portions 46a and 46a of rack retainer 46. Coil spring 6 is compressed between rack retainer 46 and bottom wall 15a of cap member 15, so that ball bearing 5, more specifically, the outer race of ball bearing 5 is pressed against raised straight rail portion 43 of middle portion 41 of rack bar 40.

Thus, like in the first embodiment 100, the meshed engagement between toothed rack portion 41a of rack bar 40 and pinion gear 2a of pinion shaft 2 is assuredly made mainly by the biasing action effected by coil spring 6 through ball bearing 5, and undesired pivotal motion of rack bar 40 is suppressed or at least minimized mainly by disc spring 35 through concave supporting surfaces 45a and 45a of supporting member 45.

In the above-mentioned embodiments 100, 200 and 300, V-shaped bearing sheets 34 and 47 constructed of a metal are employed. If desired, such bearing sheets 34 and 47 may be removed. However, in such case, supporting surfaces 7a and 7a (or 45a and 45a) of supporting member 7 (or 45) are lined with a low friction plastic. Of course, in stead of the supporting surfaces 7a or 45a of supporting member 7 or 45, slanted surfaces 28a and 28a (or 47a and 47a) of rack bar 3 (or 40) may be lined with such plastic.

The entire contents of Japanese Patent Application 2005-044942 filed Feb. 22, 2005 are incorporated herein by reference.

Although the invention has been described above with reference to the embodiments of the invention, the invention is not limited to such embodiments as described above. Various modifications and variations of such embodiments may be carried out by those skilled in the art, in light of the above description.

1. A rack and pinion steering device comprising:
a pinion shaft being adapted to be rotated by a steering wheel, the pinion shaft having a pinion gear formed thereon;
a rack bar having at a front surface thereof a toothed rack portion meshed with the pinion gear of the pinion shaft;
a rotating member being arranged to support a rear surface of the rack bar while being permitted to rotate when the rack bar moves axially;
a first biasing mechanism biasing the rotating member toward an actually meshed portion between the toothed rack portion of the rack bar and the pinion gear of the pinion shaft; and
a supporting member being arranged to slidably support the rear surface of the rack bar.

2. A rack and pinion steering device as claimed in claim 1, further comprising a second biasing mechanism biasing the supporting member toward the actually meshed portion between the toothed rack portion and the pinion gear.

3. A rack and pinion steering device as claimed in claim 2, in which a biasing force produced by the first biasing mechanism is larger than a biasing force produced by the second biasing mechanism.

4. A rack and pinion steering device as claimed in claim 3, in which the first biasing mechanism has a spring constant larger than a spring constant of the second biasing mechanism.

5. A rack and pinion steering device as claimed in claim 2, in which the second biasing mechanism comprises a disc spring.

6. A rack and pinion steering device as claimed in claim 2, further comprising a cap member that holds the second biasing mechanism, the cap member comprising a first holding portion that holds the first biasing mechanism and a second holding portion that holds the second biasing mechanism.

7. A rack and pinion steering device as claimed in claim 6, further comprising a housing for housing the supporting member, and in which the cap member is formed with an externally threaded part, the cap member being connected to the housing using the externally threaded part as fastening means.

8. A rack and pinion steering device as claimed in claim 1, in which the supporting member comprises:
supporting portions that are arranged at both sides of the rotating member; and
a bearing sheet of metal put on the supporting portions, the bearing sheet bearing the rear surface of the rack bar.

9. A rack and pinion steering device as claimed in claim 8, in which the bearing sheet comprises:
two bearing portions respectively put on the supporting portions; and
a center portion by which the two bearing portions are integrally connected.

10. A rack and pinion steering device as claimed in claim 9, in which the center portion of the bearing sheet is formed with an opening through which a part of the rotating member projects to contact the rear surface of the rack bar.

11. A rack and pinion steering device as claimed in claim 1, in which the supporting member comprises a pair of supporting portions that are arranged at both sides of the rotating member respectively.

12. A rack and pinion steering device as claimed in claim 1, in which both the rotating member and the supporting member are arranged to contact all the time the rack bar.

13. A rack and pinion steering device as claimed in claim 1, in which at least a surface of the supporting member that actually contacts the rear surface of the rack bar is constructed of a plastic.

14. A rack and pinion steering device comprising:
a pinion shaft being adapted to be rotated by a steering wheel, the pinion shaft having a pinion gear formed thereon;
a rack bar having at a front surface thereof a toothed rack portion meshed with the pinion gear of the pinion shaft;
a rotating member being arranged to support a rear surface of the back bar while being permitted to rotate when the rack bar moves axially;
a biasing mechanism biasing the rotating member toward an actually meshed portion between the toothed rack portion of the rack bar and the pinion gear of the pinion shaft; and
a sliding member slidably contacing the rear surface of the rack bar to support the rack bar.

15. A rack and pinion steering device as claimed in claim 14, in which the sliding member comprises:
sliding portions being arranged at both sides of the rotating member; and
a bearing sheet of metal put on the sliding portions, the bearing sheet bearing the rear surface of the rack bar.

16. A rack and pinion steering device as claimed in claim 15, in which the bearing sheet is coated with a low friction plastic.

17. A rack and pinion steering device as claimed in claim 14, in which a biasing force produced by the biasing mechanism is larger than a biasing force with which the sliding member is biased toward the rear surface of the rack bar.

18. A rack and pinion steering device as claimed in claim 14, in which at least a surface of the sliding member that actually contacts the rear surface of the rack bar is constructed of a plastic.

19. A rack and pinion steering device comprising:
a pinion shaft being adapted to be rotated by a steering wheel, the pinion shaft having a pinion gear formed thereon;
a rack bar having at a front surface thereof a toothed rack portion meshed with the pinion gear of the pinion shaft;
a first supporting member being arranged to support a rear surface of the rack bar with a predetermined biasing force; and
a second supporting member being arranged at a back side of the rack bar and constructed to control movement of the rack bar when the rack bar is applied with an external force greater than the predetermined biasing force.

20. A rack and pinion steering device as claimed in claim 19, in which the second supporting member contacts the rack bar when the external force applied to the rack bar is smaller than the predetermined biasing force.

21. A rack and pinion steering device as claimed in claim 20, in which the second supporting member comprises:
supporting portions being arranged at both sides of the rotating member; and
a bearing sheet of metal put on the supporting portions, the bearing sheet bearing the rear surface of the rack bar.

22. A rack and pinion steering device as claimed in claim 21, in which the bearing sheet is coated with a low friction plastic.

23. A rack and pinion steering device as claimed in claim 19, in which at least a surface of the second supporting member that actually contacts the rear surface of the rack bar is constructed of a plastic.

24. A rack and pinion steering device as claimed in claim 1, in which the rear surface of the rack bar comprises:
a raised straight rail portion to which the rotating member operatively contacts; and
two slanted surfaces that extend in different directions from the raised straight rail portion and slidably contact respective slanted surfaces defined by the supporting member.

25. A rack and pinion steering device as claimed in claim 24, further comprising a second biasing mechanism that biases the supporting member toward the actually meshed portion between the toothed rack portion and the pinion gear through the two slanted surfaces of the supporting member and the slanted surfaces of the rack member.

26. A rack and pinion steering device as claimed in claim 25, in which the slanted surfaces of the supporting member are concave in shape and the slanted surfaces of the rack bar are convex in shape.

27. A rack and pinion steering device as claimed in claim 1, in which the rotating member is a ball bearing which comprises an inner race, an outer race and balls rotatably disposed between the inner and outer races.
